(19) United States
(12) Patent Application Publication
(10) Pub. No.: US 2024/0372367 A1
(43) Pub. Date: Nov. 7, 2024

(54) CHARGING/DISCHARGING SYSTEM, METHOD OF CONTROLLING CHARGING/DISCHARGING SYSTEM, AND COMPUTER PROGRAM

(71) Applicant: GS Yuasa International Ltd., Kyoto (JP)

(72) Inventors: Hiroaki ENDO, Kyoto-shi, Kyoto (JP); Takafumi TAKUMA, Kyoto-shi, Kyoto (JP)

(21) Appl. No.: 18/556,626

(22) PCT Filed: Jan. 31, 2022
(86) PCT No.: PCT/JP2022/003546

§ 371 Date: Oct. 20, 2023

(30) Foreign Application Priority Data
Apr. 22, 2021 (JP) 2021-072222

(51) Int. Cl. H02J 3/32; B60L 53/60; B60L 55/00; B60L 58/12; H02J 3/38; H02J 7/00

(52) U.S. Cl. CPC H02J 3/322; B60L 53/60; B60L 55/00; B60L 58/12; H02J 3/38; H02J 7/00032; H02J 7/0048; H02J 2300/24

(57) ABSTRACT

A charging/discharging system for a distributed power supply that is interconnectable with a power grid 1 includes: a conversion circuit 22; a control unit 25 that controls the conversion circuit 22; and a charging/discharging unit 51 that is connected to the power grid 1 and the conversion circuit 22 so as to enable charging of electricity to a vehicle energy storage apparatus. The control unit 25 controls an output Iac_2 of the conversion circuit 22 such that a received power Pinv from the power grid 1 becomes a target value during charging the vehicle energy storage apparatus by the charging/discharging unit 51.

### CROSS REFERENCE TO RELATED APPLICATIONS

This application is a National Stage Application, filed under 35 U.S.C. § 371, of International Application No. PCT/JP2022/003546, filed Jan. 31, 2022, which international application claims priority to and the benefit of Japanese Application No. 2021-072222, filed Apr. 22, 2021; the contents of both of which are hereby incorporated by reference in their entirety.

### BACKGROUND

### Technical Field

The present invention relates to a charging/discharging system that performs charging and discharging of an energy storage apparatus of a vehicle.

### Description of Related Art

In recent years, electrification of vehicles has been in progress in consideration of the environment. In view of such circumstances, a charging infrastructure for electric vehicles (EV) and plug-in hybrid electric vehicles (PHEV) has been constructed.

Further, there has been a demand for a system capable of supplying electricity to an electric load when a power failure occurs during a disaster or the like. Patent Document JP-A-2020-10442 discloses a bidirectional charging/discharging device (a charging/discharging stand) that performs discharging from an energy storage apparatus mounted on a vehicle in addition to charging of the energy storage apparatus mounted on the vehicle.

### BRIEF SUMMARY

From a viewpoint of energy management, there is room for improvement in order to efficiently operate both of a distributed power supply such as a solar power generating system (PV system) and an energy storage apparatus of a vehicle.

According to an aspect of the present invention, there is provided a charging/discharging system that performs charging and discharging of an energy storage apparatus mounted on a vehicle.

According to one aspect of the present invention, there is provided a charging/discharging system for a distributed power supply being interconnectable with a power grid. The charging/discharging system includes: a conversion circuit; a control unit configured to control the conversion circuit; and a charging/discharging unit connected to the power grid and the conversion circuit and being capable of charging electricity to a vehicle energy storage apparatus. The control unit is configured to control an output of the conversion circuit such that a received power from the power grid becomes a target value during charging the vehicle energy storage apparatus by the charging/discharging unit.

With such a configuration, it is possible to suppress an increase in the received power from the power grid due to charging of electricity to the vehicle energy storage apparatus. The distributed power supply and the vehicle energy storage apparatus can be efficiently operated.

### BRIEF DESCRIPTION OF THE FIGURES

FIG. 1 is a block diagram of a charging/discharging system.

FIG. 2 is a perspective view of a charging/discharging station.

FIG. 3 is a perspective view of a charging/discharging stand.

FIG. 4 is a block diagram of the charging/discharging stand.

FIG. 5 is a block diagram illustrating a received power constant control during charging by the charging/discharging system.

FIG. 6 is a block diagram illustrating a received power variable control by the charging/discharging system.

FIG. 7 is a view illustrating an overall configuration of a remote monitoring control system.

FIG. 8 is a view illustrating a power conditioner with a storage battery that integrally includes the charging/discharging unit.

FIG. 9 is a block diagram of a charging/discharging system that uses the power conditioner with the storage battery that integrally includes the charging/discharging unit.

### DETAILED DESCRIPTION OF VARIOUS EMBODIMENTS

A charging/discharging system for a distributed power supply that is interconnectable with a power grid includes: a conversion circuit; a control unit that controls the conversion circuit; and a charging/discharging unit that is connected to the power grid and the conversion circuit so as to enable charging of electricity to a vehicle energy storage apparatus. The control unit is configured to control an output of the conversion circuit such that a received power from the power grid becomes a target value during charging the vehicle energy storage apparatus by the charging/discharging unit.

In the above-mentioned configuration, the distributed power supply may be a small-scale power generation facility that is arranged in a distributed manner adjacently to a power demand site. More specifically, the distributed power supply may be a solar power generation panel, a wind power generation apparatus, or a biomass power generation apparatus.

As the conversion circuit and the control unit, those provided to a power conditioner (PCS) may be used. However, the configuration where the conversion circuit and the control unit are provided is not limited to this. A charging/discharging unit provided to a charging/discharging device that is a separate body from a power conditioner may be used. The charging/discharging unit is not limited to such a configuration.

The vehicle energy storage apparatus may be an energy storage apparatus for driving a vehicle that is mounted on an electric vehicle having no internal combustion engine (for example, a battery electric vehicle (BEV), an AGV or a vehicle similar to these vehicles). Alternatively, the vehicle energy storage apparatus may be an energy storage apparatus for driving a vehicle that is mounted on a plug-in hybrid electric vehicle (PHEV) or a hybrid electric vehicle (HEV) that use an internal combustion engine in combination.

The vehicle energy storage apparatus is not limited to a vehicle energy storage apparatus that is fixedly mounted on a vehicle, and may be a vehicle energy storage apparatus that is detachably mounted on a vehicle.

According to the charging/discharging system having the above-mentioned configuration, the control unit controls an output of the conversion circuit such that the received power becomes a target value during charging. For example, the control unit performs a control such that power for charging is assisted by an output that is obtained by converting power generated by the distributed power supply. By performing such a control, it is possible to charge electricity to the vehicle energy storage apparatus without excessively increasing the reception of electricity from the power grid and hence, it is possible to suppress the increase in an electricity rate. The distributed power supply and the vehicle energy storage apparatus can be efficiently operated.

This charging/discharging system provides a charging infrastructure for electric vehicles that will rapidly spread in the future while suppressing the increase in an electricity rate brought about by the operation of the system operation. Accordingly, this charging/discharging system contributes to the environment (the suppression of carbon dioxide emission). Further, the charging/discharging system is useful as a business continuity plan (BCP) measure at the time of the occurrence of power failure. As a result, the introduction of the charging/discharging system by public institutions and/or private institutions is enhanced.

The charging/discharging system may further include an energy storage unit being capable of discharging electricity to the charging/discharging unit via the conversion circuit.

The energy storage unit may be configured by a plurality of secondary batteries that are connected in series and/or in parallel. However, the configuration of the energy storage unit is not limited.

According to the charging/discharging system having the above-mentioned configuration, the power stored in the energy storage unit can be outputted via the conversion circuit so as to assist the power for charging the vehicle energy storage apparatus by the charging/discharging unit. For example, inexpensive electricity from the power grid at night is stored in the energy storage unit, and power for charging the vehicle energy storage apparatus can be assisted by the stored electricity. Accordingly, it is possible to suppress the increase in an electricity rate brought about by the operation of the charging/discharging system. Further, the control unit controls an output of the conversion circuit such that the received power becomes a target value. Accordingly, it is possible to prevent with certainty the power stored in the energy storage unit from flowing back to the power grid.

In the charging/discharging system, the control unit may include a communication unit being capable of communicating with the charging/discharging unit.

The communication unit may be a communication unit that performs wireless communication, a communication unit that performs wired communication, or a communication unit that performs both communications.

According to this charging/discharging system, the distributed power supply and/or the energy storage unit, and the vehicle energy storage apparatus connected to the charging/discharging unit can be operated in a cooperative manner.

For example, in a case where the conversion circuit and the control unit are provided to the power conditioner (connected to the distributed power supply and the energy storage unit) and the charging/discharging unit is provided to the charging/discharging device (connected to the vehicle energy storage apparatus), the distributed power supply, the energy storage unit, and the vehicle energy storage apparatus can be optimally operated corresponding to the time and the case by the sharing of information and the transmission of control instructions via the communication unit.

In the charging/discharging system, the charging/discharging unit may acquire or estimate a state of charge (SOC) of the vehicle energy storage apparatus.

The charging/discharging unit may be capable of acquiring the SOC of the vehicle energy storage apparatus by communication with the vehicle via a charging/discharging cable. However, the SOC acquisition mode is not limited to such a mode.

According to the charging/discharging system having the above-mentioned configuration, the energy management that also uses the power demand-supply adjustment capability by a vehicle (vehicle energy storage apparatus) connected to the charging/discharging unit can be performed. Accordingly, the peak cut performance, the load leveling performance, or the demand response (DR) achievement performance of the charging/discharging system can be enhanced. Further, a virtual power plant (VPP) can constructed using the charging/discharging system.

In the charging/discharging system, the communication unit may transmit information that includes a state of the conversion circuit and information that includes a state of the charging/discharging unit to an information processing apparatus.

The information processing apparatus may be a remote monitoring server, a customer data management server, or a blockchain system.

According to the charging/discharging system having the above-mentioned configuration, the charging/discharging system can grasp operation states and operation histories of the conversion circuit and the charging/discharging unit from a remote place. A stakeholder of the charging/discharging system can optimally operate the distributed power supply, the energy storage unit and the vehicle energy storage apparatus depending on the time and the case.

In the charging/discharging system, the control unit may change the target value of the received power based on a predicted value of a power generation amount of the distributed power supply and a predicted value of power consumption of a demand facility.

The demand facility may be an on-premises load whose power consumption can be easily predicted.

According to the charging/discharging system having the above-mentioned configuration, by changing such a target value of received power, a power flow flowing from the power grid to the power receiving point can be adjusted. Accordingly, an energy management system (EMS) can be realized simply by the power conditioner and the like. By performing the prediction of the power supply and demand and the adjustment of power demand using the control unit and the communication unit of the power conditioner, it is possible to cope with the increase of DR and the decrease of DR at a low cost without using a dedicated EMS controller.

The charging/discharging system may include a housing that houses the conversion circuit, the control unit, and the charging/discharging unit, and a charging/discharging cable may extend from the housing.

The charging/discharging system may include a first converter circuit, a second converter circuit, and a third converter circuit that are connected to the conversion circuit. The distributed power supply may be connected to the first converter circuit, the energy storage unit may be connected to the second converter circuit, and the charging/discharging cable may be connected to the third converter circuit.

The housing may be a housing (a so-called plate) made of metal. However, the configuration of the housing is not limited. The housing may have an openable and closable lid, or the housing may have a wall that partitions the housing into a space for accommodating the conversion circuit and the control unit and a space for accommodating the charging/discharging unit. Alternatively, a housing that accommodates the conversion circuit and the control unit and a housing that accommodates the charging/discharging unit may be arranged adjacently to each other and may be fixed to each other.

According to the charging/discharging system having the above-mentioned configuration, compared with the system that is configured by the power conditioner and the charging/discharging device that is provided as a separate body from the power conditioner, the commonization of parts can be enhanced thus realizing the space saving and the reduction of cost.

Hereinafter, embodiments will be described in detail with reference to the drawings.

### First Embodiment

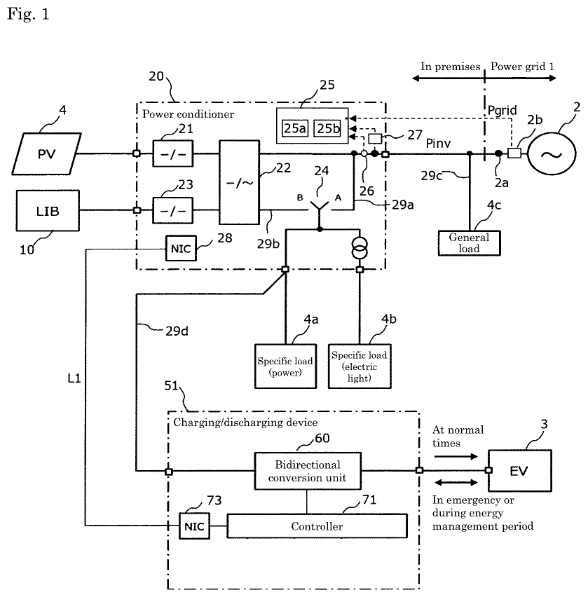

A charging/discharging system for a distributed power supply illustrated in FIG. 1 includes: a power conditioner 20 that is connected to a solar power generation panel 4; and a charging/discharging device 51 that charges electricity to an energy storage apparatus of a vehicle (hereinafter referred to as “automobile”) 3. The solar power generation panel 4 is an example of distributed power supply. The charging/discharging device 51 is one example of a charging/discharging unit.

### 1. Configuration and Manner of Operation of Power Conditioner

To the power conditioner 20, an energy storage unit 10 is connected, in addition to the solar power generation panel 4. The energy storage unit 10 may be configured by a plurality of secondary batteries, for example, a plurality of lithium ion batteries that are connected in series and/or in parallel. The power conditioner 20 is preferably be a three-phase series energy storage system that can supply power to electric loads in a wide range. For example, with the use of a so-called power conditioner with the storage battery that integrally includes the energy storage unit 10, space saving can be realized.

The power conditioner 20 includes a first converter circuit 21, a second converter circuit 23, a bidirectional inverter circuit 22, and a control device 25.

The solar power generation panel 4 is connected to the first converter circuit 21. The first converter circuit 21 is a DC/DC converter, and outputs an output voltage (a direct current) of the solar power generation panel 4 after boosting. The first converter circuit 21 may be a boost chopper.

The energy storage unit 10 is connected to the second converter circuit 23. The second converter circuit 23 is a bidirectional DC/DC converter, and performs charging/discharging of the energy storage unit 10. The second converter circuit 23 may be a bidirectional chopper.

The energy storage unit 10 can store surplus power from the solar power generation panel 4 and power from a power grid 1 that uses a system power supply 2 as an alternating current power supply via the second converter circuit 23. The energy storage unit 10, in a case where a power generation amount of the solar power generation panel 4 is short, discharges power so as to compensate for the shortage of the power generation amount via the second converter circuit 23.

The bidirectional inverter circuit 22 is a bidirectional conversion circuit that selectively performs the reverse conversion (inverting) that converts direct current power to alternating current power, and forward conversion (converting) that converts alternating current power to direct current power. The bidirectional inverter circuit 22 is connected to the power grid 1. The bidirectional inverter circuit 22 is an example of the conversion circuit.

The power conditioner 20 incorporates a current detection unit 26 and a voltage detection unit 27 therein. The current detection unit 26 is, for example, a through-type Hall sensor, and detects a current flowing through a power line that connects the bidirectional inverter circuit 22 and the power grid 1 to each other. The voltage detection unit 27 detects a voltage of the power line that connects the bidirectional inverter circuit 22 and the power grid 1 to each other. A detected current and a detected voltage are inputted to the control device 25. The power conditioner 20 includes the current detection unit 26 and the voltage detection unit 27. Accordingly, even in a case where an external measuring instrument 2b is not provided at a power receiving point 2a as described later, the power conditioner 20 can perform an output control (a received power constant control, a received power variable control, and the like) of the bidirectional inverter circuit 22.

The control device 25, based on a detected current and a detected voltage, calculates power (effective power) Pinv that flows back and forth via the power line that connects the power conditioner 20 and the power grid 1. Here, the power Pinv of the forward power flow (the power flow from the power grid 1 to the power conditioner 20) is expressed by a positive value, and the power Pinv of the reverse power flow (the power flow from the power conditioner 20 to the power grid 1) is expressed by a negative value. The control device 25 controls an output of the bidirectional inverter circuit 22 using a calculated power Pinv.

The control device 25 includes: a central processing unit (CPU) 25a that functions as a processor; and a memory 25b that functions as a memory unit. The memory 25b stores a program for predicting the supply and the demand of power and a program for changing a target value of received power. The control device 25 is an example of a control unit.

As described later, the control device 25 controls an output of the bidirectional inverter circuit 22 such that the received power from the power grid 1 becomes a target value during charging of electricity to the energy storage apparatus of the automobile 3 by the charging/discharging device 51. The power conditioner 20 assists the power for charging by the charging/discharging device 51 while adjusting the output power of the bidirectional inverter circuit 22 based on the input power from the solar power generation panel 4 and/or the energy storage unit 10. With such processing, it is possible to suppress an increase in the reception of power from the power grid 1 due to charging of electricity to the energy storage apparatus of the automobile 3.

For a public institution or a private institution that is considering the introduction of a charging/discharging system, it is not desirable in terms of the system operation that the reception of power from the power grid 1 be increased because of charging of electricity to energy storage apparatuses of automobiles 3. By charging power to the automobile 3 at normal times, it is possible to supply power from the automobile 3 in an emergency. However, it is not desirable that an electricity rate be increased due to frequent charging of electricity to the automobile 3 in preparation for an emergency the occurrence of which is unpredictable.

By assisting power for charging generated by the charging/discharging device 51 while adjusting the output of the bidirectional inverter circuit 22 by the control device 25, it is possible to suppress such an increase in an electricity rate. By adopting this control function, the introduction of a charging/discharging system is accelerated. For example, the introduction of a charging/discharging system by a private company or the like that provides a car-sharing service is accelerated.

A power line 29a is branched from a power line that connects the bidirectional inverter circuit 22 and the power grid 1 (the power line between the bidirectional inverter circuit 22 and the current detection unit 26), and the power line 29a extends to a switching circuit 24 (a contact A) in the power conditioner 20. A contact B of the switching circuit 24 is connected to the bidirectional inverter circuit 22 via a power line 29b.

A three-phase specific load 4a that includes a power load such as an elevator and a single-phase specific load (for example, an electric light) 4b are connected to the switching circuit 24 via a transformer.

Backup power is supplied to the specific loads 4a and 4b from at least one of the solar power generation panel 4, the energy storage unit 10, and the charging/discharging device 51 during a power failure of the power grid 1. That is, electric power discharged from the energy storage apparatus of the automobile 3 is supplied to the specific loads 4a and 4b via the charging/discharging device 51. By connecting the specific loads 4a and 4b to the contact B of the switching circuit 24, the power supplied from the solar power generation panel 4 and/or the energy storage unit 10 is supplied to the specific loads 4a and 4b via the bidirectional inverter circuit 22 and the power line 29b. Such a charging/discharging system is useful as a countermeasure against BCP.

The power conditioner 20 includes a communication board 28. The communication board 28 may be a network interface card (NIC). The communication board 28 is communicably connected to the control device 25 via a communication line (not illustrated). The communication board 28 is an example of a communication unit (a first communication unit).

### 2. Configuration and Manner of Operation of Charging/Discharging Device

The charging/discharging device 51 includes a communication board 73 that can communicate with the communication board 28 of the power conditioner 20 via a communication line L1 or by wireless communication. The communication board 73 (a second communication unit) may be a network interface card (NIC).

In the charging/discharging system, communication board 28 of the power conditioner 20 may function as a master board, and the communication board 73 of the charging/discharging device 51 may function as a slave board.

The charging/discharging device 51 discharges the energy storage apparatus of the automobile 3 in an emergency such as a power failure. A bidirectional conversion unit 60 incorporated in the charging/discharging device 51 converts direct current power from the automobile 3 into alternating current power and supplies the alternating current power to the specific loads 4a and 4b via a power line 29d.

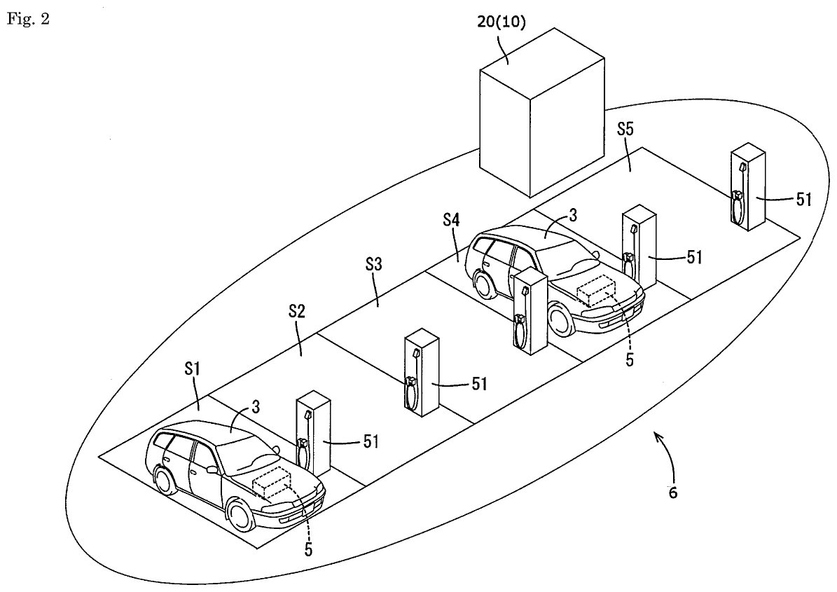

As illustrated in FIG. 2, a plurality of charging/discharging devices (hereinafter, referred to as “charging/discharging stands”) 51 may be provided in a charging/discharging station 6. The power conditioner 20 (10) with the storage battery that can communicate with the charging/discharging stands 51 may be disposed adjacently to the charging/discharging station 6. Alternatively, the power conditioner 20 and/or the energy storage unit 10 may be disposed at a position away from the charging/discharging station 6.

The charging/discharging station 6 may be installed in a public site such as a public parking lot. Alternatively, the charging/discharging station 6 may be installed in the premises of a company or an individual.

As illustrated in FIG. 2, the charging/discharging station 6 may be a centralized type station where parking spaces S1 to S5 are arranged adjacently to each other, or may be a distributed type station where parking spaces are arranged in a distributed manner (for example, arranged on another floor of a building) although not illustrated. In FIG. 2, the charging/discharging stand 51 is disposed in each parking space (S1, S2, . . . ). However, the present invention is not limited to such a configuration. Although not illustrated in the drawing, the single charging/discharging stand 51 may be installed in a single parking space.

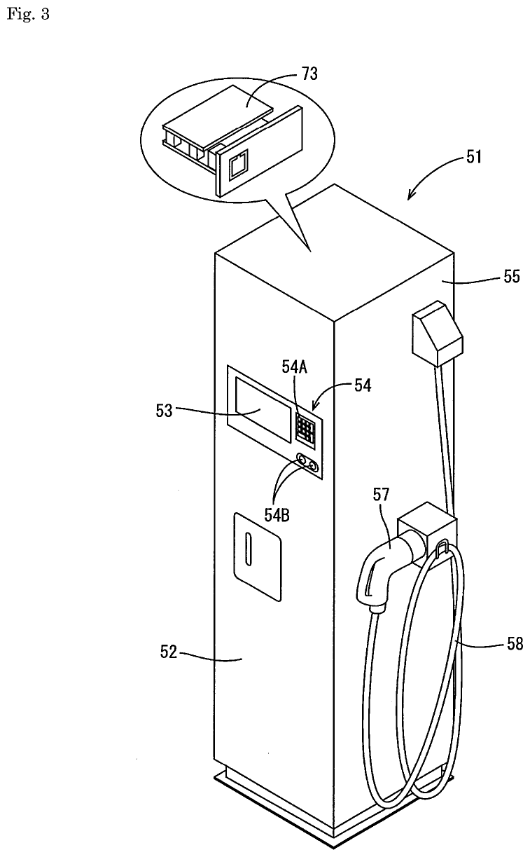

As illustrated in FIG. 3, the charging/discharging stand 51 has a box shape elongated in the vertical direction. A display panel 53 and an operation unit 54 are attached to a front wall 52 of a housing of the charging/discharging stand 51. The operation unit 54 includes an input key 54A (or a touch panel) and an execution key 54B. A charging/discharging connector 57 and the charging/discharging cable 58 are held on a side wall 55 of the housing. The charging/discharging stand 51 includes the communication board 73 in the housing.

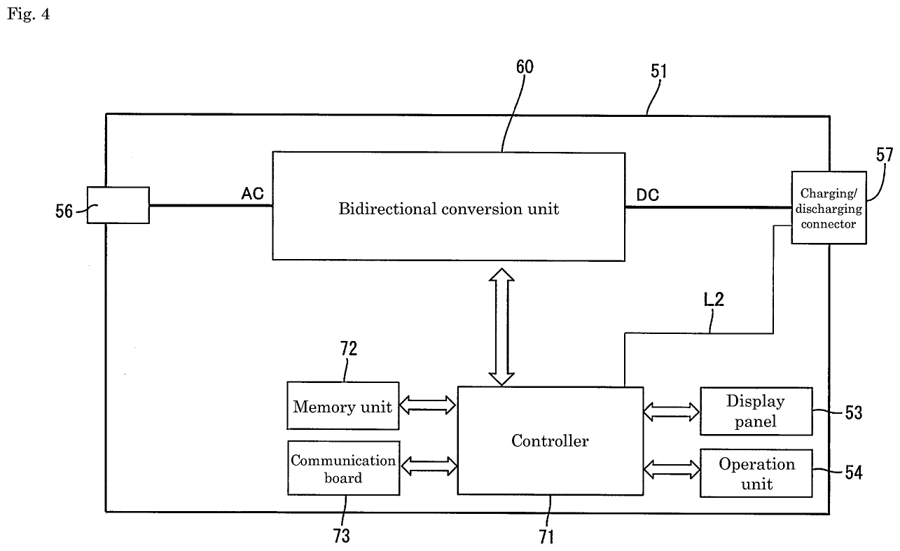

FIG. 4 is a block diagram illustrating an electrical configuration of the charging/discharging stand 51. The charging/discharging stand 51 includes the bidirectional conversion unit 60, the controller 71, a memory unit 72, the communication board 73, the display panel 53, and the operation unit 54.

The communication board 73 may be used for communication with another charging/discharging stand 51 installed in the charging/discharging station 6. With respect to the specification of the communication, either the wired communication or the wireless communication may be adopted.

One end of the bidirectional conversion unit 60 is connected to an AC terminal 56, and the other end is connected to the charging/discharging connector 57. The AC terminal 56 is connected to the power line 29d illustrated in FIG. 1. The bidirectional conversion unit 60 is a bidirectional conversion circuit that selectively performs the forward conversion (converting) that converts alternating current power to direct current power, and reverse conversion (inverting) that converts direct current power to alternating current power.

The controller 71 controls the bidirectional conversion unit 60 by giving a command to the bidirectional conversion unit 60.

The charging/discharging connector 57 is inserted into a connection portion (an inlet) of the automobile 3 illustrated in FIG. 2, and the charging/discharging connector 57 is made to engage with the charging/discharging connector of the automobile 3 by fitting engagement.

Due to the fitting engagement of the connectors, the bidirectional conversion unit 60 of the charging/discharging stand 51 and the energy storage apparatus of the automobile 3 (hereinafter, referred to as an “in-vehicle battery”) 5 illustrated in FIG. 2 are electrically connected to each other. The charging/discharging stand 51 performs charging or discharging the in-vehicle battery 5 using the bidirectional conversion unit 60. Specifically, the charging/discharging stand 51 performs charging of the in-vehicle battery 5 by allowing the bidirectional conversion unit 60 to perform a forward conversion operation, and performs discharging of the in-vehicle battery 5 by causing the bidirectional conversion unit 60 to perform a reverse conversion operation.

Further, due to the fitting engagement of the connectors, the controller 71 illustrated in FIG. 4 is communicably connected to the automobile 3 via the communication line L2, and the control unit 71 receives SOC information of the in-vehicle battery 5.

The controller 71 calculates (estimates) a charging amount and a discharging amount of the in-vehicle battery 5 based on an output of the bidirectional conversion unit 60. In this manner, the controller 71 monitors a change of the SOC of the in-vehicle battery 5 caused by charging or discharging of the in-vehicle battery 5.

### 3. Other Configurations

As illustrated in FIG. 1, a power line 29c is branched from a power line that connects the power conditioner 20 and the power grid 1 (between the power conditioner 20 and the power receiving point 2a of power grid 1), and a general load 4c in the premises is connected to the power line 29c. The general load 4c may include a three-phase load and a single-phase load.

The specific load 4a of three-phases, the specific load 4b of a single-phase, and the general load 4c of three-phases or single phase are examples of demand facilities.

The external measuring instrument (external transducer) 2b is provided corresponding to a power receiving point 2a of the power grid 1. The external measuring instrument 2b detects a received power current and a grid voltage, and calculates received power (effective power) Pgrid. The calculated received power Pgrid is inputted to the control device 25 of the power conditioner 20. Here, the power Pgrid of the forward power flow (the power flow from the power grid 1 to the premises) is expressed by a positive value, and the power Pgrid of the reverse power flow (the power flow from the premises to the power grid 1) is expressed by a negative value.

### 4. Received Power Constant Control

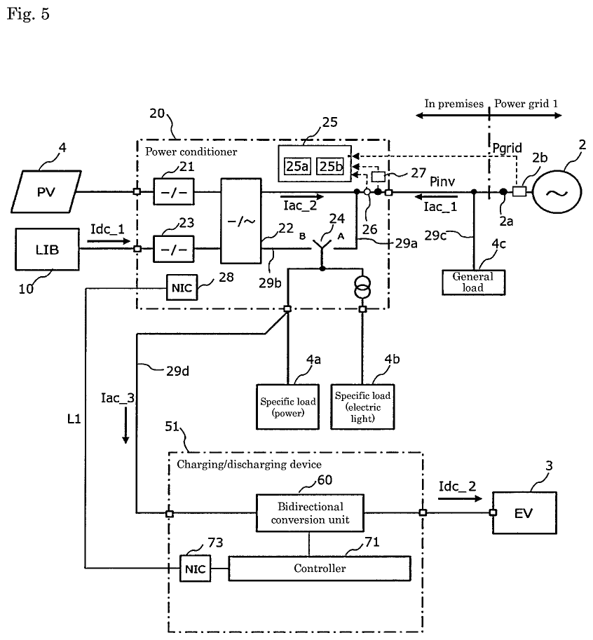

With reference to FIG. 5, an example of the flow of power is described where power is charged to the automobile 3 by the charging/discharging stand 51.

In the switching circuit 24 in the power conditioner 20, the specific loads 4a, 4b are connected to the contact A. Before the charging/discharging stand 51 starts charging of the automobile 3, power Pinv received from the power grid 1 is supplied to specific loads 4a, 4b. At this point of time, the power Pinv is, for example, 600 watts (W), an alternating current Iac_1 of the forward current is, for example, 40 amperes, and the power is consumed by the specific loads 4a and 4b.

When the charging/discharging stand 51 starts charging of the automobile 3, the direct current Idc_1 is discharged from the energy storage unit 10 in accordance with an instruction from the control device 25, and the alternating current Iac_2 (for example, 40 amperes) is outputted from the bidirectional inverter circuit 22 so as to maintain the power Pinv at a target value. The control device 25 controls the output of the bidirectional inverter circuit 22 such that the power Pinv becomes a positive target value (for example, 600 W) (a received power constant control).

In a state where the received power Pinv is maintained at 600 W, power is consumed by the specific loads 4a and 4b, and the alternating current Iac_3 (for example, 40 amperes) flows through the power line 29d. The charging/discharging stand 51 converts alternating current power into direct current power by bidirectional conversion unit 60, and the charging/discharging stand 51 outputs direct current Idc_2 (for example, 12 amperes). In this manner, charging of the automobile 3 is performed by the charging/discharging stand 51.

By performing such a received power constant control using the control device 25, it is possible to charge electricity to the automobile 3 without excessively increasing the reception of power from the power grid 1 and hence, and it is possible to suppress the increase in an electricity rate. The reception of power (600 W) of a forward current from the power grid 1 is continued even during discharging of electricity from the energy storage unit 10. Accordingly, it is possible to prevent with certainty that the power stored in the energy storage unit from reversely flowing back to the power grid 1.

FIG. 5 illustrates the example where power is supplied only from the energy storage unit 10. However, power to be charged to the automobile 3 may be supplied from the solar power generation panel 4, or power may be supplied from both the energy storage unit 10 and the solar power generation panel 4. In any cases, the control device 25 performs a received power constant control and hence, it is possible to suppress an increase in electricity rate caused by an operation of the charging/discharging system.

A received power constant control by the control device 25 may be performed based on received power Pgrid at the power receiving point 2a of the power grid 1 in place of a received power Pinv. A control based on a detection value of the external measuring instrument 2b has a tendency that an error in control is slightly increased compared with a control based on a detection value of the current detection unit 26 and a detection value of the voltage detection unit 27 in the power conditioner 20. However, the control based on a detection value of the external measuring instrument 2b can also take into account or monitor the power consumption generated by the general load 4c in the premises.

### 5. Received Power Variable Control

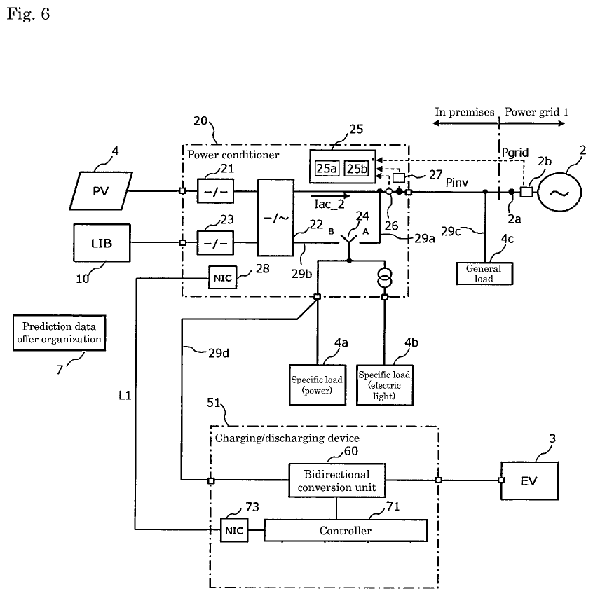

As illustrated in FIG. 6, the communication board 28 of the power conditioner 20 obtains prediction data of a power generation amount of the solar power generation panel 4 in future (for example, the next day) from a prediction data offer organization 7, and stores the prediction data in the memory 25b of the control device 25. A predicted value of the power generation amount of the solar power generation panel 4 can be obtained from a predicted value of a solar radiation amount. The predicted value of the solar radiation amount is obtained from weather information.

The control device 25 predicts the power consumption of demand facilities 4a, 4b, and 4c in the premises in future (for example, the next day), and stores the predicted power consumption in future in the memory 25b. The power consumption of the demand facilities 4a, 4b, and 4c in the premises can be predicted from past data. For example, data of the power consumption of the next day can be predicted by statistically processing data of the power consumption for the past several days.

As describe previously, the communication board 28 of the power conditioner 20 is made to function as a master board, and the communication board 73 of the charging/discharging stand 51 may be made to function as a slave board. As a result, the control device 25 can sequentially acquire or calculate SOC information (a dischargeable electric amount, a chargeable electric amount) of the in-vehicle battery 5 of the automobile 3 that is connected to the charging/discharging stand 51. Based on the SOC information, the control device 25 can grasp the power demand-supply adjustment capability of the in-vehicle battery 5 of the automobile 3. The control device 25 also sequentially acquires or calculates SOC information of the energy storage unit 10.

In a case where the discharging of electricity from the automobile 3 is scheduled at a certain point of time in future (for example, on the next day), the control device 25 may decrease a target value of the received power Pinv (or Pgrid) in a received power constant control during a period from the arrival of the certain point of time to a point of time that the discharging of electricity from the automobile 3 is performed.

In a case where the charging of electricity to the automobile 3 is scheduled at a certain point of time in future (for example, on the next day), the control device 25 may increase a target value of the received power Pinv (or Pgrid) in a received power constant control during a period from the arrival of the certain point of time to a point of time that the charging of electricity to the automobile 3 is performed.

By changing such a target value of received power (received power variable control), a power flow flowing from the power grid 1 to the receiving point 2 a can be adjusted, and an energy management system (EMS) can be realized by the power conditioner 20, the energy storage unit 10, the charging/discharging stand 51, and the in-vehicle battery 5 of the automobile 3. By performing the prediction of the power supply and demand and the adjustment of power demand using the control device 25 and the communication board 28 of the power conditioner 20, it is possible to cope with the increase of DR and the decrease of DR at a low cost without using a dedicated EMS controller.

According to this charging/discharging system, the solar power generation panel 4 and the energy storage unit 10, and the in-vehicle battery 5 of the automobile 3 connected to the charging/discharging stand 51 can be operated in a cooperative manner. With the use of the in-vehicle battery 5 besides the energy storage unit 10 for the demand adjustment, the charging/discharging system can flexibly cope with a demand response command and the like. By performing a power interchange between the energy storage unit 10 and the in-vehicle battery 5, the charging/discharging system can prevent the occurrence of a state where the SOC of either one of the energy storage unit 10 or the in-vehicle battery 5 is excessively increased or lowered so that the life of the battery is shortened.

In this manner, the peak cut performance, the load leveling performance, or the demand response achievement performance of the charging/discharging system can be improved without impairing the expected life of the energy storage unit 10 and the in-vehicle battery 5. Further, VPP can be constructed using the charging/discharging system.

### Second Embodiment

The communication board 28 (see FIG. 1) that is disposed in the power conditioner 20 and functions as a master board transmits information that includes a state of the power conditioner 20 (the bidirectional inverter circuit 22) and information that includes a state of the charging/discharging stand 51 to an information processing apparatus such as a remote monitoring server.

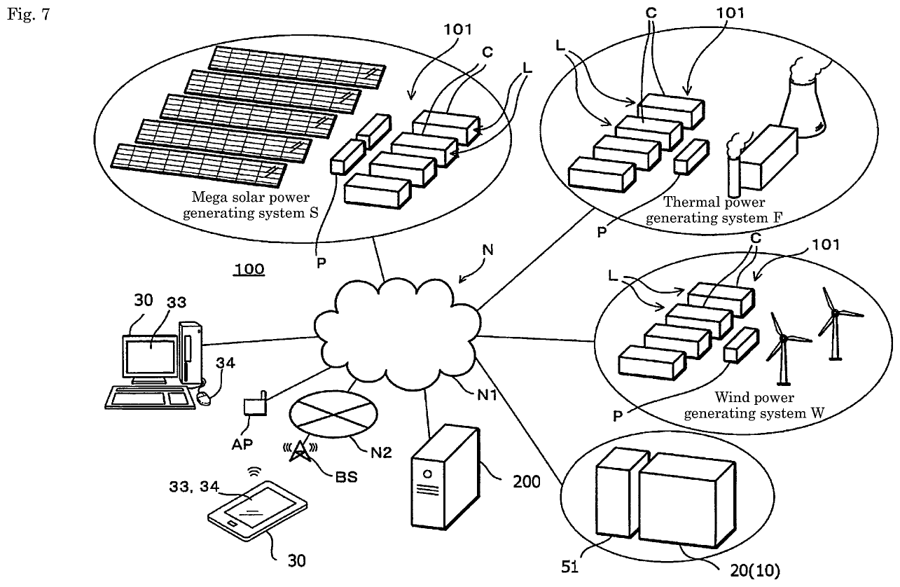

FIG. 7 is a view illustrating an overall configuration of a remote monitoring system 100. The remote monitoring system 100 enables an access from remote places to information relating to energy storage devices and power supply associated apparatuses that are included in a mega solar power generating system S, a thermal power generating system F, and a wind power generating system W. Similarly, the remote monitoring system 100 enables an access from remote places to information relating to power conditioner 20 (10) with the storage battery and the charging/discharging stand 51.

A power conditioner P and a storage battery system 101 are provided in parallel in the power generating systems S, F, and W. The storage battery system 101 may be configured by arranging a plurality of containers C each accommodating a group of power storage modules L in parallel. The power conditioner P is also accommodated in the container C. Alternatively, the group of power storage modules L and power conditioner P may be disposed in a building (a power storage chamber).

In the remote monitoring system 100, a communication device is mounted on/connected to the storage battery system 101 or the power supply associated apparatus in each of the systems S, F, W, 20 (10), and 51 that are to be monitoring objects. The communication device may communicate with a battery management unit (BMU) included in each group of power storage modules L to receive information relating to the energy storage devices. The communication device may be a communication board 28, 73 of a network interface card type (see FIG. 3). The remote monitoring system 100 includes: the communication devices; a server apparatus 200 that collects information from the communication devices; client apparatuses 30 that allow clients to browse the collected information; and a network N that is a communication medium between the apparatuses.

The server apparatus 200 includes a web server function, and offers information obtained from the communication devices that are mounted on or are connected to the respective apparatuses that are to be the monitoring objects in response to an access from the client apparatus 30.

The network N includes: a public communication network N1 that is a so-called Internet; and a carrier network N2 that realizes wireless communication in accordance with a predetermined mobile communication standard. The public communication network N1 includes a general optical line, and the network N includes a dedicated line connected to the server apparatus 2. The carrier network N2 includes a base station BS, and the client apparatuses 30 can communicate with the server apparatus 200 from the base station BS via the network N. An access point AP is connected to the public communication network N1, and the client apparatuses 30 can communicate with the server apparatus 200 from the access point AP via the network N.

The client apparatus 30 may be a personal computer of a desktop type or a laptop type, or may be a so-called smartphone or a communication terminal of a tablet type. The client apparatus 30 includes a controller, a memory unit, a communicating unit, a display unit 33, and an operation unit 34. The memory unit stores a client program including a web browser that the controller reads and executes.

A user who has logged in through a login screen displayed on a web browser of the client apparatus 30 can access the information offered from the server apparatus 200 and relating to a system in which the user is involved.

According to the remote monitoring system 100, a user can grasp, from a remote place, operation states and operation histories of the power conditioner 20, the energy storage unit 10, the charging/discharging stand 51, and the in-vehicle battery 5 (see FIG. 2) in the charging/discharging system. The user can also access the communication board 23 of the power conditioner 20 and the communication board 73 of the charging/discharging stand 51 so as to change setting of the power conditioner 20 and the charging/discharging stand 51 and to give operation instructions to the power conditioner 20 and the charging/discharging stand 51. A stakeholder of the charging/discharging system can optimally operate the solar power generation panel 4, the energy storage unit 10, and the in-vehicle battery 5 depending on the time and the case.

### Third Embodiment

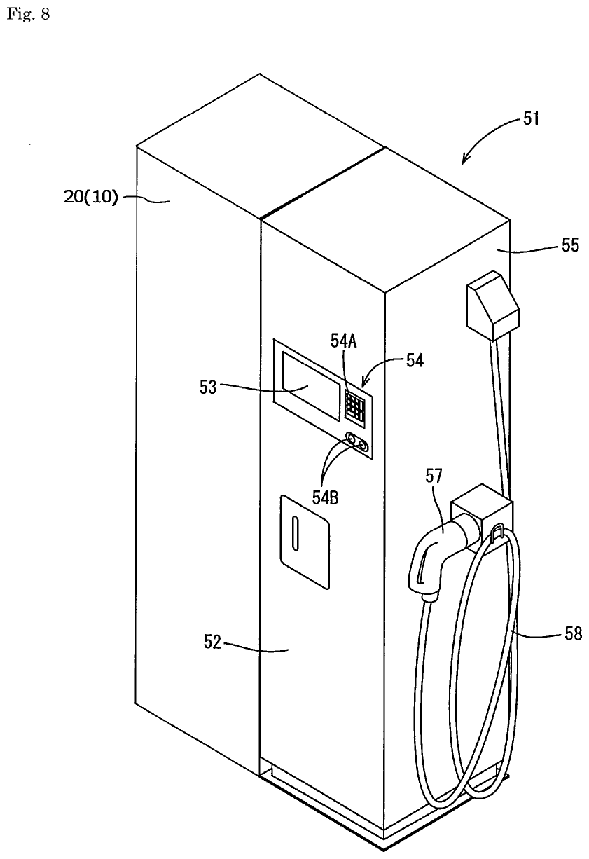

A power conditioner 20 (10) with a storage battery illustrated in FIG. 8 that is integrally provided with the charging/discharging unit has a housing that houses a bidirectional inverter circuit, a control device, and a charging/discharging unit, and a charging/discharging cable 58 extends from the housing.

In the charging/discharging system according to the first exemplary embodiment illustrated in FIG. 1, the first converter circuit 21 and the second converter circuit 23 are connected to the bidirectional inverter circuit 22 of the power conditioner 20. The charging/discharging device 51 that incorporates the bidirectional conversion unit 60 is provided as a separate body from the power conditioner 20.

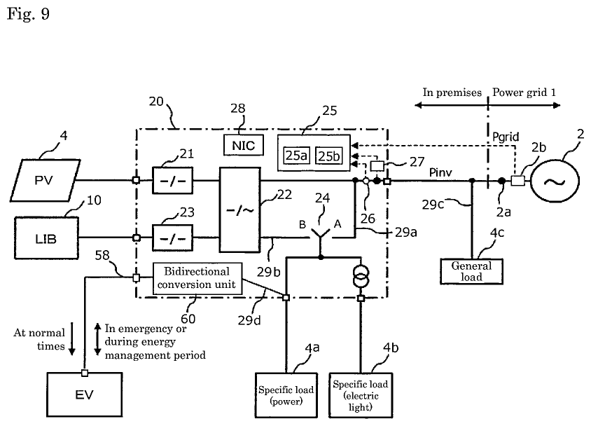

On the other hand, a charging/discharging stand (charging/discharging unit) 51 is integrally formed with a power conditioner 20 (10) with the storage battery illustrated in FIG. 8. As illustrated in FIG. 9, to an internal bidirectional inverter circuit 22, a first converter circuit 21 connected to a solar power generation panel 4, a second converter circuit 23 connected to an energy storage unit 10, and a bidirectional conversion unit 60 connected to a charging/discharging cable 58 and forming a third converter circuit are connected. The bidirectional conversion unit 60 may be controlled by a control device 25 of the power conditioner 20. The control device 25 of the power conditioner 20 may be communicably connected to the automobile 3 so as to receive and monitor the SOC information of an in-vehicle battery 5.

According to such a charging/discharging system, compared with the system that is configured by the power conditioner 20 and the charging/discharging stand 51 that is provided as a separate body from the power conditioner (FIG. 1 and the like), the commonization of parts can be enhanced thus realizing the space saving and the reduction of cost. For example, one communication board 28 may perform both the internal communication and the external communication.

The present invention is not limited to the above-described embodiments, and appropriate combinations of the above-described embodiments and the following configurations are also included in the technical scope of the present invention.

(1) A charging/discharging system for a distributed power supply being interconnectable with a power grid, the charging/discharging system including:
a conversion circuit;
a control unit configured to control the conversion circuit; and
a charging/discharging unit connected to the conversion circuit and being capable of performing charging of the vehicle energy storage apparatus,
in which
the control unit includes a communication unit being capable of communicating with the charging/discharging unit, and
the communication unit is configured to transmit information including a state of the conversion circuit and information including a state of the charging/discharging unit to an information processing apparatus.

(2) The charging/discharging system according to the above-mentioned (1), in which the control unit or the charging/discharging unit acquires or estimates a state of charge of the vehicle energy storage apparatus.

(3) A charging/discharging system for a distributed power supply being interconnectable with a power grid, the charging/discharging system including:
a conversion circuit;
a control unit configured to control the conversion circuit; and
a charging/discharging unit connected to the conversion circuit and being capable of charging electricity to a vehicle energy storage apparatus,
in which the control unit is configured to changes a target value of a received power from the power grid based on a predicted value of a power generation amount of the distributed power supply and a predicted value of power consumption of a demand facility.

(4) A charging/discharging system for a distributed power supply being interconnectable with a power grid, the charging/discharging system including:
a conversion circuit;
a control unit configured to control the conversion circuit;
a charging/discharging unit connected to the conversion circuit and being capable of charging electricity to a vehicle energy storage apparatus; and
a housing that houses the conversion circuit, the control unit and the charging/discharging unit,
in which a charging/discharging cable extends from the housing.

(5) A charging/discharging system for a distributed power supply being interconnectable with a power grid, the charging/discharging system including:
a conversion circuit;
a control unit configured to control the conversion circuit; and
a first converter circuit, a second converter circuit and a third converter circuit connected to the conversion circuit,
in which
a distributed power supply is connected to the first converter circuit,
an energy storage unit is connected to the second converter circuit, and
a charging/discharging cable is connected to the third converter circuit.

In the above-described embodiment, the system that includes the charging/discharging unit has been described. However, the technical concept of the present invention is also applicable to a charging system that uses a distributed power supply and a charging unit but does not have a discharging function. The technical scope of the present invention also includes the following configurations.

(6) A charging system for a distributed power supply being interconnectable with a power grid, the charging system including:
a conversion circuit;
a control unit configured to control the conversion circuit; and
a charging unit connected to the power grid and the conversion circuit and being capable of charging electricity to a vehicle energy storage apparatus,
in which the control unit is configured to control an output of the conversion circuit such that a received power from the power grid becomes a target value during charging the vehicle energy storage apparatus by the charging unit.

(7) The charging system according to the above-mentioned (6), further including an energy storage unit being capable of discharging electricity to the charging unit via the conversion circuit.

1. A charging/discharging system for a distributed power supply being interconnectable with a power grid, the charging/discharging system comprising:
a conversion circuit;
a control unit configured to control the conversion circuit; and
a charging/discharging unit connected to the power grid and the conversion circuit and being capable of charging electricity to a vehicle energy storage apparatus,
wherein the control unit is configured to control an output of the conversion circuit such that a received power from the power grid becomes a target value during charging the vehicle energy storage apparatus by the charging/discharging unit.

2. The charging/discharging system according to claim 1, further comprising an energy storage unit being capable of discharging electricity to the charging/discharging unit via the conversion circuit.

3. The charging/discharging system according to claim 1, wherein the control unit includes a communication unit being capable of communicating with the charging/discharging unit.

4. The charging/discharging system according to claim 3, wherein the charging/discharging unit acquires or estimates a state of charge of the vehicle energy storage apparatus.

5. The charging/discharging system according to claim 3, wherein the communication unit is configured to transmit information that includes a state of the conversion circuit and information that includes a state of the charging/discharging unit to an information processing apparatus.

6. The charging/discharging system according to claim 1, wherein the control unit is configured to change the target value of the received power based on a predicted value of a power generation amount of the distributed power supply and a predicted value of power consumption of a demand facility.

7. The charging/discharging system according to claim 1, further comprising a housing that houses the conversion circuit, the control unit, and the charging/discharging unit,
wherein a charging/discharging cable extends from the housing.

8. The charging/discharging system according to claim 1, further comprising a first converter circuit, a second converter circuit, and a third converter circuit that are connected to the conversion circuit,
wherein
a distributed power supply is connected to the first converter circuit,
the energy storage unit is connected to the second converter circuit, and
a charging/discharging cable is connected to the third converter circuit.

9. A method of controlling a charging/discharging system for a distributed power supply being interconnectable with a power grid,
the charging/discharging system including: a conversion circuit; a control unit configured to control the conversion circuit; and a charging/discharging unit connected to the power grid and the conversion circuit and being capable of charging electricity to a vehicle energy storage apparatus,
the method comprising controlling an output of the conversion circuit by the control unit such that a received power from the power grid becomes a target value during charging the vehicle energy storage apparatus by the charging/discharging unit.

10. A computer program for controlling a charging/discharging system for a distributed power supply being interconnectable with a power grid,
the charging/discharging system including: a conversion circuit; a control unit configured to control the conversion circuit; and a charging/discharging unit connected to the power grid and the conversion circuit and being capable of charging electricity to a vehicle energy storage apparatus,
the computer program causing a computer to execute processing of controlling an output of the conversion circuit such that a received power from the power grid becomes a target value during charging the vehicle energy storage apparatus by the charging/discharging unit.
